(19) United States
(12) Patent Application Publication
(10) Pub. No.: US 2015/0345991 A1
(43) Pub. Date: Dec. 3, 2015

(54) STROKE DETECTION DEVICE, STROKE DETECTION METHOD, STROKE DETECTION SYSTEM, OPERATION LEVER UNIT, AND OPERATION LEVER STROKE DETECTION SYSTEM

(71) Applicant: KOMATSU LTD., Minato-ku, Tokyo (JP)

(72) Inventors: Masato Kageyama, Oyama-shi (JP); Yoshiyuki Nagaya, Oyama-shi (JP); Hiroyuki Chikugo, Oyama-shi (JP); Daigoh Fujii, Oyama-shi (JP)

(73) Assignee: Komatsu Ltd., Tokyo (JP)

(21) Appl. No.: 14/425,428

(22) PCT Filed: Oct. 6, 2014
(86) PCT No.: PCT/JP14/76706

§ 371 Date: Mar. 3, 2015

(30) Foreign Application Priority Data
Oct. 18, 2013 (JP) 2013-217284

(51) Int. Cl. G01D 5/14; F15B 19/00

(52) U.S. Cl. CPC G01D 5/14; F15B 19/005

(57) ABSTRACT

A stroke detection device includes: four rods provided, moveably along respective axial directions, side by side on a same circumference of a device body, the stroke detection device detecting a change in relative positions of the four rods at a time the rods perform a stroke with respect to the device body; a magnet disposed to each of the rods such that a magnetic field is generated between rods adjacent to each other on the circumference and that the magnetic field varies at a time the rods adjacent to each other on the circumference perform a stroke relatively; and magnetic field detection units disposed on at least three positions between the magnets adjacent to each other in the device body, each of the magnetic field detection unit detecting the magnetic field between the magnets and outputting an electric signal in accordance with the detected magnetic field.

### FIELD

The present invention relates to a stroke detection device, a stroke detection method, a stroke detection system, an operation lever unit, and an operation lever stroke detection system.

### BACKGROUND

Some operation lever units for operating work machines are configured to output electric signals according to operating states of the operation levers. An operation lever is mounted on a device body via a universal joint, for example, and is able to be tilted in an arbitrary direction with respect to the device body. The operation lever is provided with a cam plate which is fixedly attached to an end portion close to the device body.

On the device body, on a portion opposite to the cam plate, four rods are disposed at positions at equal intervals on the circumference about the joint portion of the operation lever. Each of the rods includes a magnet therein, and the rods are disposed so as to be able to move in parallel with each other along the respective shafts. Between each of the rods and the device body, a spring applying reaction force to the operation lever is provided.

On the device body, a magnetic field detection unit such as a Hall element is provided between the magnets disposed in the rods. The magnetic field detection unit is configured to detect a magnetic field of each magnet, and output an electric signal in accordance with the magnitude of the detected magnetic field.

In the operation lever unit configured as described above, if no operation force is applied to the operation lever, each of the rods is arranged at a neutral position with respect to the device body. When the operation lever is tilted from this state, the rod performs a stroke via the cam plate. When the rod performs a stroke, as the position of the magnet is changed with respect to the magnetic field detection unit, the magnitude of the magnetic field detected by the magnetic field detection unit also varies. The stroke amount of the rod corresponds to the tilting direction, the tilting amount, and the operating state of the operation lever. Thereby, an electric signal in accordance with the operating state of the operation lever is output from the magnetic field detection unit (see Patent Literature 1, for example).

### CITATION LIST

### Patent Literature

Patent Literature 1: Japanese Patent Application Laid-open No. 2007-107696

### SUMMARY

### Technical Problem

Meanwhile, the operation lever unit of Patent Literature 1 needs separate magnetic field detection unit for each of the rods to be detected. This means that in the operation lever unit including four rods, an operating state of the operation lever cannot be detected unless four magnetic field detection units are disposed on the device body. Each magnetic field detection unit needs a signal line for outputting an output signal for each detection unit. As such, in the operation lever unit in which a magnetic field detection unit is required for each of the rods, when it is mounted on a work machine, connection work of signal lines corresponding to the number of rods is required, which may cause complication in assembling work.

In particular, in an operation lever unit for operating a work machine, the stroke amount of the same rod is detected in a duplicated manner by two magnetic field detection units, to thereby improve the reliability of the output electric signals. As such, in order to perform such redundant detection, in the case of an operation lever unit including four rods, eight magnetic field detection units are required in total, and the number of signal lines is also doubled accordingly. As such, assembling work is further complicated. Moreover, eight input ports are also required on an input controller side.

In view of the above, an object of the present invention is to provide a stroke detection device, a stroke detection method, a stroke detection system, an operation lever unit, and an operation lever stroke detection system, capable of facilitating assembling work by reducing the number of signal lines.

### Solution to Problem

To achieve the above-described object, a stroke detection device according to the present invention includes four rods provided, moveably along respective axial directions, side by side on a same circumference of a device body, the stroke detection device detecting a change in relative positions of the four rods at a time the rods perform a stroke with respect to the device body, wherein a magnet is disposed to each of the rods such that a magnetic field is generated between rods adjacent to each other on the circumference and that the magnetic field varies at a time the rods adjacent to each other on the circumference perform a stroke relatively, and magnetic field detection units are disposed on at least three positions between the magnets adjacent to each other in the device body, each of the magnetic field detection unit detecting the magnetic field between the magnets and outputting an electric signal in accordance with the detected magnetic field.

Moreover, in the above-described stroke detection device according to the present invention, the four rods are disposed at positions having equal intervals from each other on the circumference, each of the rods is arranged at a predetermined neutral position with respect to the device body at a time no operation force is applied thereto, and one or two of the rods perform a stroke from the neutral positions in accordance with magnitude of an operation force at a time the operation force is applied thereto while at least two of the rods maintain the neutral positions, and the stroke detection device further comprises an input signal processing unit configured to generate a detection signal in accordance with a change in a position of each of the rods with respect to the device body, based the electric signal output from each of the magnetic field detection units.

Moreover, in the above-described stroke detection device according to the present invention, the respective magnetic field detection units are configured to output electric signals having a same value for same relative positions of a rod positioned on an upstream side and a rod positioned on a downstream side which are previously set along the circumference on which the four rods are provided side by side, and the input signal processing unit is configured to acquire two addition results by adding the electric signals output from the magnetic field detection units adjacent to each other, from among the respective electric signals provided from the three magnetic field detection units, and set the acquired two addition results as detection signals, respectively.

Moreover, a stroke detection system according to the present invention includes: the stroke detection device, wherein the magnetic field detection unit is disposed at each of four positions between the magnets adjacent to each other in the device body, and the input signal processing unit is configured to acquire four addition results by adding the electric signals output from the magnetic field detection unit adjacent to each other, from among respective electric signals provided from the four magnetic field detection units, and generate the detection signals; and an abnormality determination device configured to perform processing to further add addition results of positions diagonal to each other from among the four addition results acquired through the input signal processing unit to calculate a sum, set each of two adjacent addition results, from among the four addition results, as detection signals at a time the calculated sum is a predetermined value, and generate an error signal indicating that an abnormality occurs at a time the calculated sum is not the predetermined value.

Moreover, a stroke detection method according to the present invention for detecting a change in relative positions of four rods at a time at least one or two of the four rods perform a stroke with respect to a device body, wherein the four rods are provided, moveably along respective axial directions, side by side at positions having equal intervals from each other on a same circumference of the device body, and configured such that each of the four rods is arranged at a predetermined neutral position with respect to the device body at a time no operation force is applied thereto, that one or two of the rods perform a stroke from the neutral positions in accordance with magnitude of an operation force at a time the operation force is applied thereto while at least two of the rods maintain the neutral positions, and that a direction of the magnetic field between the rods vary at a time the rods adjacent to each other perform a stroke relatively, includes: detecting magnetic fields at at least three positions between the rods adjacent to each other; and specifying a rod which performs a stroke from the neutral position and a stroke amount of the rod based on a direction of each of the detected magnetic fields.

Moreover, an operation lever unit according to the present invention includes: the stroke detection device; and an operation lever disposed tiltably with respect to the device body, wherein the operation lever unit is configured such that the rod performs a stroke with respect to the device body in accordance with an operating state of the operation lever at a time the operation lever is operated with respect to the device body.

Moreover, an operation lever stroke detection system according to the present invention includes: the stroke detection device, wherein the magnetic field detection unit is disposed at each of four positions between the magnets adjacent to each other in the device body, and the input signal processing unit is configured to acquire four addition results by adding the electric signals output from the magnetic field detection unit adjacent to each other, from among respective electric signals provided from the four magnetic field detection units, and generate the detection signals; an abnormality determination device configured to perform processing to further add addition results of positions diagonal to each other from among the four addition results acquired through the input signal processing unit to calculate a sum, set each of two adjacent addition results, from among the four addition results, as detection signals at a time the calculated sum is a predetermined value, and generate an error signal indicating that an abnormality occurs at a time the calculated sum is not the predetermined value; and an operation lever disposed tiltably with respect to the device body, wherein the operation lever unit is configured such that the rod performs a stroke with respect to the device body in accordance with an operating state of the operation lever at a time the operation lever is operated with respect to the device body.

Moreover, a stroke detection device according to the present invention includes two rods provided, movably along respective axial directions, to a device body side by side, the stroke detection device detecting a change in relative positions of the rods, wherein a magnet is provided to each of the two rods such that a magnetic field is generated between the two rods and that the magnetic field varies at a time the rods perform a stroke relatively, and a magnetic field detection unit is disposed at a position between the magnets in the device body, the magnetic field detection unit detecting the magnetic field between the magnets and outputting an electric signal in accordance with the detected magnetic field.

Moreover, a stroke detection method detects a change in relative positions of two rods provided, movably along the respective axial directions, to a device body side by side, and includes: detecting a direction of a magnetic field between the two rods; and detecting a change in the relative positions of the two rods based on the detected direction of the magnetic field.

### Advantageous Effects of Invention

According to the present invention, as changes of relative positions of rods are detected from changes in directions of the magnetic fields between the magnets provided to the rods, there is no need to provide a magnetic field detection unit to each of the rods, whereby it is possible to reduce the number of signal lines from the magnetic field detection unit.

### BRIEF DESCRIPTION OF DRAWINGS

FIG. 1 illustrates an operation lever unit to which a stroke detection device, according to an embodiment of the present invention, is applied, which is a cross-sectional view when the operation lever is in an upright posture.

FIG. 2 is a cross-sectional view of the case where the operation lever is tilted in the operation lever unit illustrated in FIG. 1.

FIG. 3-1 is a cross-sectional view taken along the line A-A in FIG. 1.

FIG. 3-2 is a drawing illustrating, in a developed manner, a change in relative positions of magnets when only a #2 piston performs a full stroke and detection results of magnetic field detection units.

FIG. 4 is a block diagram of an operation lever stroke detection system equipped with the operation lever unit illustrated in FIG. 1.

FIG. 5 schematically illustrates a content of processing performed by the input signal processor and the abnormality determination device illustrated in FIG. 4, explaining the case where all pistons are arranged at neutral positions.

FIG. 6 schematically illustrates a content of processing performed by the input signal processor and the abnormality determination device illustrated in FIG. 4, explaining the case where only a #1 piston performs a full stroke.

FIG. 7 schematically illustrates a content of processing performed by the input signal processor and the abnormality determination device illustrated in FIG. 4, explaining the case where only a #2 piston performs a full stroke.

FIG. 8 schematically illustrates a content of processing performed by the input signal processor and the abnormality determination device illustrated in FIG. 4, explaining the case where the #1 piston and the #2 piston perform a full stroke.

FIG. 9 schematically illustrates a content of processing performed by the input signal processor and the abnormality determination device illustrated in FIG. 4, explaining the case where the #1 piston performs a 50% stroke and the #2 piston performs a full stroke.

FIG. 10 illustrates a first modification of an operation lever unit, which is an illustration schematically illustrating a content of processing performed by an input signal processor and an abnormality determination device in the case where only a #1 piston performs a full stroke.

FIG. 11 illustrates a second modification of an operation lever unit including two pistons, which is an illustration schematically illustrating a content of processing performed by an input signal processor in the case where two pistons are arranged at neutral positions.

### DESCRIPTION OF EMBODIMENTS

Hereinafter, preferred embodiments of a stroke detection device, a stroke detection method, a stroke detection system, an operation lever unit, and an operation lever stroke detection system, according to the present invention, will be described in detail with reference to the accompanying drawings.

(Configuration of Operation Lever Unit)

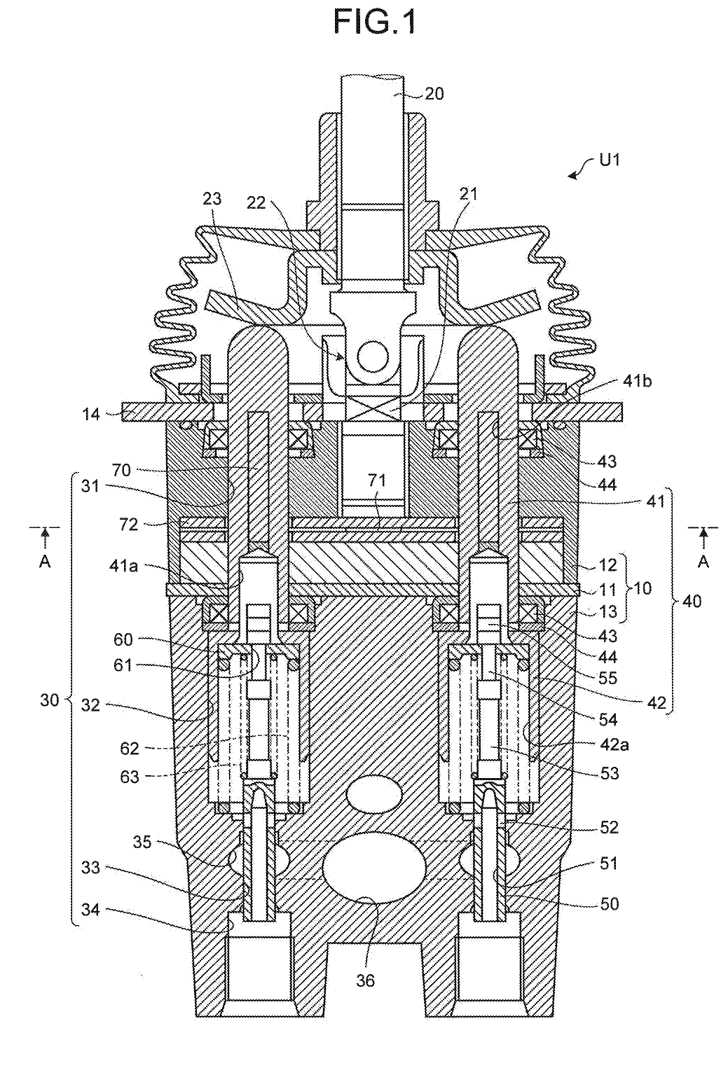

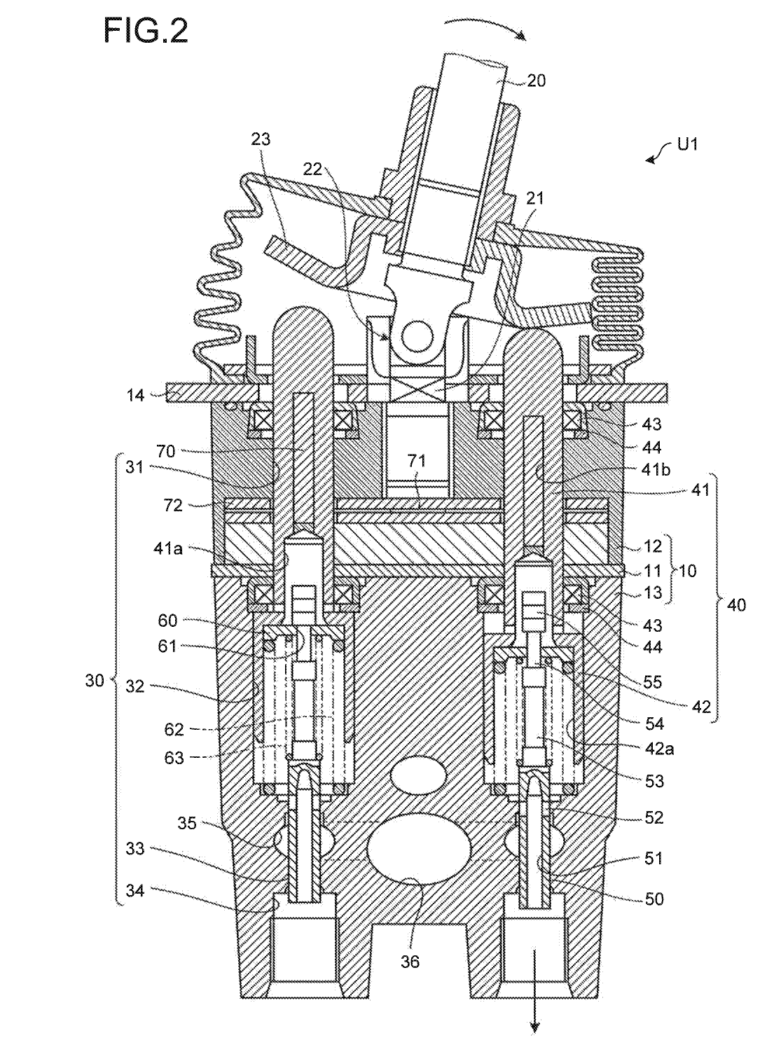

FIG. 1 and FIG. 2 illustrate an operation lever unit U1 including a stroke detection device which is an embodiment of the present invention. The operation lever unit U1, exemplary illustrated herein, includes an operation lever 20 disposed to be able to be tilted with respect to a device body 10, and when the operation lever is operated to be tilted, the operation lever unit U1 outputs a pilot oil pressure in accordance with the operating state, and also outputs detection signals which are electric signals. In the present embodiment, the operation lever unit U1 for operating a work machine by operating the operation lever 20 is exemplary shown.

The device body 10 is configured by joining an upper body element 12 and a lower body element 13 via an intermediate plate 11. On the upper surface of the upper body element 12, a support shaft 21 and a mounting plate 14 are mounted. The support shaft 21 is a shaft member for mounting the operation lever 20, disposed in a state of protruding upward from a position serving as the center of the upper body element 12. The mounting plate 14 is in a flat plate shape, constituting the upper surface of the device body 10.

Although not shown, the operation lever 20 is disposed at a position where it is operable in a state of sitting on the driver's seat of the work machine, and is mounted on the support shaft 21 of the device body 10 via a universal joint 22. The universal joint 22 of the present embodiment includes two shafts which are orthogonal to each other and also orthogonal to the support shaft 21, and is capable of tilting the operation lever 20 in an arbitrary direction with respect to the device body 10.

On the base end portion of the operation lever 20, a cam plate 23 is provided. The cam plate 23 is a plate-like member provided so as to protrude from the outer peripheral surface of the operation lever 20. The cam plate 23 is configured such that when the operation lever is arranged orthogonal to the upper surface of the device body 10 (hereinafter referred to as an “upright posture”) as illustrated in FIG. 1, distances from the upper surface of the device body 10 are equal in the whole periphery. As illustrated in FIG. 2, when the operation lever 20 is tilted, the cam plate 23 is also operated together, whereby the distance between the upper surface of the device body 10 and the cam plate 23 is reduced in the tilted direction of the operation lever 20.

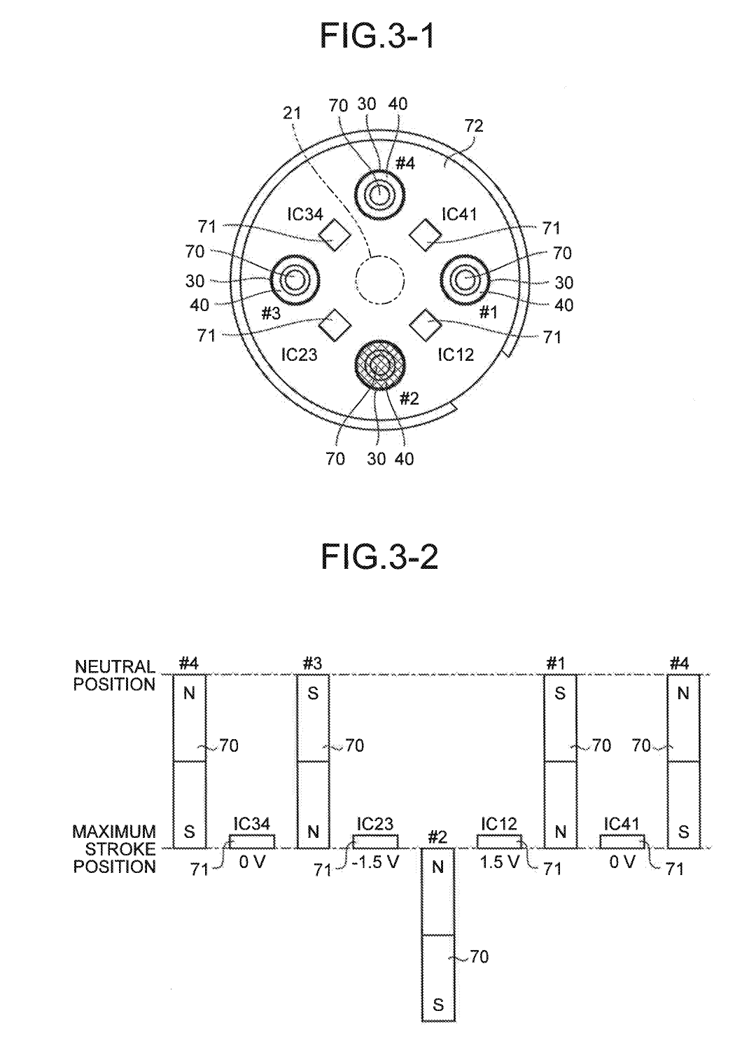

In the device body 10, a position covered by the cam plate 23 includes four piston holes 30 as illustrated in FIG. 1, FIG. 2, and FIG. 3-1. As illustrated in FIG. 3-1, the piston holes 30 are formed to be in parallel with each other at positions having equal intervals between each other on the circumference around the shaft of the support shaft 21. As illustrated in FIG. 1 and FIG. 2, each of the piston holes 30 includes a rod sliding portion 31, a sleeve sliding portion 32, a spool sliding portion 33, and a pilot output portion 34.

The rod sliding portion 31 is a portion constituting an upper end portion of the piston hole 30, and is provided to penetrate the upper body element 12. The sleeve sliding portion 32 is a portion communicating with the rod sliding portion 31, and is formed in the upper half portion of the lower body element 13. The sleeve sliding portion 32 is formed to have a larger inner diameter than that of the rod sliding portion 31. The spool sliding portion 33 is a portion communicating with the sleeve sliding portion 32, and is configured to have a smaller inner diameter than that of the rod sliding portion 31. The spool sliding portion 33 is equipped with a pump port 35. The pump port 35 is a space configured to have a large diameter than that of the spool sliding portion 33, at an intermediate position of the spool sliding portion 33. To the pump port 35, a pump pressure passage 36, formed in the lower body element 13 of the device body 10, is connected. The pilot output portion 34 is a portion communicating with the spool sliding portion 33, and is provided to be opened to the lower surface at the lower end portion of the lower body element 13. The pilot output portion 34 is configured to have a diameter larger than that of the spool sliding portion 33 but smaller than that of the sleeve sliding portion 32.

In the piston hole 30 of the device body 10, a piston 40 and a spool 50 are disposed. The piston 40 includes a columnar rod portion (rod) 41, and a cylindrical sleeve portion 42 having a larger diameter than that of the rod portion 41, which are integrally formed. The sleeve portion 42 is configured such that the length along an axial direction is shorter than that of the sleeve sliding portion 32 of the piston hole 30. The outer diameter of the sleeve portion 42 is formed to have a size capable of being inserted slidably into the sleeve sliding portion 32 of the piston hole 30. The rod portion 41 is configured such that the length along the axial direction is longer than that of the rod sliding portion 31 of the piston hole 30. The outer diameter of the rod portion 41 is formed to have a size capable of being inserted slidably into the rod sliding portion 31 of the piston hole 30. In the lower end portion of the rod portion 41, a rod accommodation hole 41a is formed. The rod accommodation hole 41a is a space having a relatively small diameter formed in the center shaft portion of the rod portion 41, and the lower end thereof communicates with a center hole 42a of the sleeve portion 42.

Each of the pistons 40 is formed such that in a state where the upper end portion of the rod portion 41 protrudes upward from the upper surface of each device body 10, the sleeve portion 42 is arranged in the sleeve sliding portion 32 of the piston hole 30, and the rod portion 41 is arranged in the rod sliding portion 31. The piston 40 arranged in the piston hole 30 of the device body 10 is able to move along each axial direction with respect to the device body 10, as the sleeve portion 42 moves in the axial direction in the sleeve sliding portion 32.

A reference sign 43 in FIG. 1 denotes an oil seal including a stopper ring 44 provided at an open end portion of the sleeve sliding portion 32 and an open end portion of the rod sliding portion 31. The oil seal 43 provided at the open end portion of the sleeve sliding portion 32 is provided such that the stopper ring 44 abuts the shoulder portion between the rod portion 41 and the sleeve portion 42. When the piston 40 moves upward with respect to the device body 10, the shoulder portion abuts the stopper ring 44 whereby upward movement of the piston 40 is restricted. The position of the piston 40 when it moves to the uppermost position is set to be in a size where the upper end of each rod portion 41 is able to abut the cam plate 23 when the operation lever 20 is disposed in an upright posture.

As illustrated in FIG. 1 and FIG. 2, the spool 50 is a columnar member inserted in a portion from the sleeve sliding portion 32 to the pilot output portion 34 in the spool sliding portion 33 of the piston hole 30. Each of the spools 50 includes a supply passage 51 and a communication hole 52. The supply passage 51 is a space formed along the longitudinal direction in the center shaft portion of the spool 50. The supply passage 51 is formed such that the upper end portion is closed while the lower end is opened to the pilot output portion 34. The communication hole 52 is an opening formed from the outer peripheral surface of the spool 50, and the inner end portion thereof communicates with the supply passage 51.

The spool 50 includes a support rod portion 53. The support rod portion 53 is a columnar member extending upward from the upper end surface of the spool 50. The upper end portion of the support rod portion 53 passes through the center hole 42a of the sleeve portion 42 and reaches the rod accommodation hole 41a. Above each of the support rod portions 53, a slide shaft portion 54 and a stopper shaft portion 55 are provided. The slide shaft portion 54 forms a column having a smaller diameter than that of the support rod portion 53. The stopper shaft portion 55 is provided at the upper end portion of the slide shaft portion 54, and is configured to be a column having a larger outer diameter than that of the slide shaft portion 54.

In the slide shaft portion 54 of the support rod portion 53, a ring plate 60 is disposed in a movable manner. The ring plate 60 is a disk-shaped member having an outer diameter capable of being inserted in the center hole 42a of the sleeve portion 42, in which the slide shaft portion 54 of the support rod portion 53 slidably penetrates a slide hole 61 formed in the center portion. The inner diameter of the slide hole 61 is formed to be smaller than the outer diameter of the stopper shaft portion 55. To the ring plate 60, an operation force spring 62 is provided between the device body 10, and an output pressure adjusting spring 63 is provided between the spool 50.

The operation force spring 62 is a coil spring for energizing the piston 40 upward via the ring plate 60. When no external force is acted on the piston 40, the piston 40 is arranged at the uppermost position with respect to the device body 10 due to the energizing force of the operation force spring 62, and the shoulder portion between the rod portion 41 and the sleeve portion 42 is in a state of abutting the stopper ring 44 (neutral position). The output pressure adjusting spring 63 is a coil spring for energizing the spool 50 in a direction separating from the ring plate 60. The energizing force of the output pressure adjusting spring 63 is set to be smaller than that of the operation force spring 62.

As is obvious from FIG. 1, if no external force is applied to the spool 50 in a state where the piston 40 is arranged at a neutral position, the spool 50 is in a state of being arranged at the uppermost position with respect to the device body 10. The respective dimensions thereof are set such that when the spool 50 is in a state of being arranged at the uppermost position with respect to the device body 10, the communication hole 52 formed in the spool 50 only opens to the sleeve sliding portion 32 of the piston hole 30 and does not communicate with the pump port 35.

Further, in the operation lever unit U1, a magnet 70 is provided to each of the four pistons 40, and four magnetic field detection sensors (magnetic field detection unit) 71 are provided to the device body 10. The magnet 70 is a bar magnet in which one end has N pole and the other has S pole, which is disposed inside a magnet hole 41b formed in the rod portion 41 of the piston 40. The directions of the magnets 70, when disposing them, are set such that the magnetic poles of adjacent magnets 70 are opposite to each other on the circumference around the support shaft 21, as illustrated in FIG. 3-2.

Although not shown, the magnetic field detection sensor 71 is configured to include two Hall elements which constitute one detection unit, for example, and detects a magnitude of a magnetic field in a first direction and a magnitude of a magnetic field in a second direction which is orthogonal thereto, and outputs an electric signal in accordance with the direction of the magnetic field calculated from the magnitudes of the magnetic fields in the two directions as a detection result. In the present embodiment, as illustrated in FIG. 3-1, each of the magnetic field detection sensors 71 is provided at a position between magnets 70 adjacent to each other on the circumference about the support shaft 21. More specifically, as illustrated in FIG. 1 and FIG. 2, the four magnetic field detection sensors 71 are provided to the upper body element 12 of the device body 10 in a state of being mounted on a common substrate 72. Each of the magnetic field detection sensors 71 outputs an electric signal in accordance with the direction of the magnetic field between the two adjacent magnets 70 on the circumference. In the present embodiment, the magnetic field detection sensor 71 is configured to output a differential voltage from a neutral position as a detection signal. Although not shown, on the substrate 72, an input/output circuit is configured such that an electric signal is output separately in accordance with the direction of the magnetic field detected by each of the magnetic field detection sensors 71. It should be noted that specific numeric values of voltages described below represent differential voltages from the neutral position described above.

All of the four magnetic field detection sensors 71 provided to the device body 10 are adjusted beforehand to have the same characteristics. Specifically, an output electric signal takes a maximum value (1.5 V) when, in the case where arrangement of the piston 40 and the magnetic field detection sensor 71 is seen from the lower side of the device body 10, as illustrated in FIG. 3-1 and FIG. 3-2, the piston 40 arranged on the upstream side in one direction along the circumferential direction, that is, in a clockwise direction for example, is at a neutral position, and the piston 40 arranged on the downstream side performs a stroke by a maximum amount. On the contrary, an output electric signal takes a minimum value (−1.5 V) when the piston 40 arranged on the downstream side is at a neutral position and the piston 40 arranged on the upstream side performs a stroke by a maximum amount. The maximum value (1.5 V) and the minimum value (−1.5 V) of electric signals are the same in all magnetic field detection sensors 71.

(Configuration of Input Signal Processor)

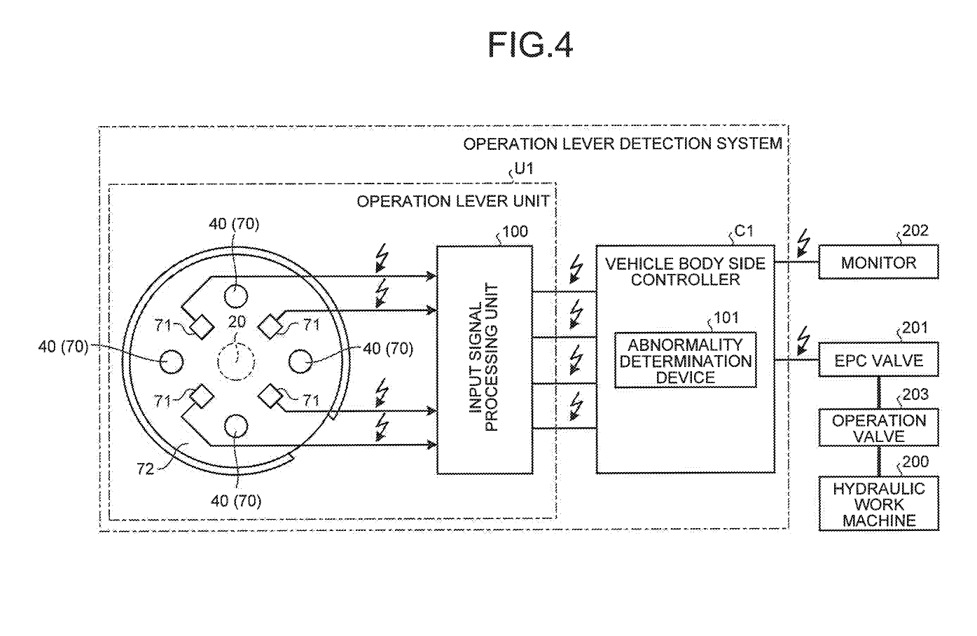

FIG. 4 is a block diagram illustrating a processing system of electric signals output from the four magnetic field detection sensors 71 in an operation lever stroke detection system. As illustrated in FIG. 4, the operation lever unit U1 is equipped with an input signal processor (input signal processing unit) 100. To the input signal processor 100, electric signals are given from the four magnetic field detection sensors 71 through different signal lines, respectively. The input signal processor 100, to which electric signals are given from the four magnetic field detection sensors 71, performs processing to acquire four addition results by adding electric signals of magnetic field detection sensors 71 adjacent to each other on the circumference of the device body 10, and output them as detection signals to the outside.

(Configuration of Abnormality Determination Device)

A work machine, to which the operation lever unit U1 is applied, is equipped with an abnormality determination device 101 in a vehicle body side controller C1 which controls driving of a hydraulic work machine 200. The abnormality determination device 101 performs processing to further add addition results of magnetic field detection sensors which are diagonal to each other, among the four addition results output from the input signal processor 100, to thereby calculate the sum, and determines whether or not the further calculated sum is a set value (0 V). If the sum obtained by further adding the addition results of the magnetic field detection sensors 71 diagonal to each other, among the four addition results, is a set value (0 V), the abnormality determination device 101 determines that there is no abnormality. If the abnormality determination device 101 determines that there is no abnormality, a detection signal in accordance with the operating state of the operation lever 20 is output from the vehicle body side controller C1 to an EPC valve 201. In contrast, if the added sum is not the set value (0 V), the abnormality determination device 101 determines that there is an abnormality. If the abnormality determination device 101 determines that there is an abnormality, the addition results output from the input signal processor 100 are discarded, and an error signal is generated and output to a monitor 202 of the work machine. Thereby, it is possible to detect whether or not abnormality occurs in respective magnetism detection unit 71 of the operation lever 20 and signal lines.

(Operation of Operation Lever Unit)

In the operation lever unit U1 configured as described above, if no operation force is applied to the operation lever 20 as illustrated in FIG. 1, the energizing force of the operation force spring 62 is equally applied to the cam plate 23 via the piston 40, whereby the operation lever 20 is arranged in an upright posture.

In this state, every communication hole 52 of the spools 50 is only opened to the sleeve sliding portion 32 of the piston hole 30, and does not communicate with the pump port 35. Accordingly, oil is never supplied as a pilot oil pressure from the pilot output portion 34 of the piston hole 30.

On the other hand, when the operation lever 20 is tilted in an arbitrary direction with respect to the device body 10, the piston 40 performs a stroke with respect to the device body 10 in accordance with the tilted direction of the operation lever 20 and the magnitude of the operation force. This means that as illustrated in FIG. 2, when the operation lever 20 is tilted, the piston 40 is pressed downward via the cam plate 23. When the pressing force applied to the piston 40 exceeds the energizing force of the operation force spring 62, the piston 40 performs a stroke with respect to the device body 10. The stroke amount of the piston 40 depends on the operation force when the operation lever 20 is tilted. The maximum stroke amount of the piston 40 is a stroke amount by which the lower end of the sleeve portion 42 abuts the inner bottom face of the sleeve sliding portion 32. When the operation force of the operation lever 20 is removed, the piston 40 returns to a neutral position by the restoring force of the operation force spring 62, and the operation lever 20 is arranged in an upright posture again.

In the operation lever unit U1 in which the operation lever 20 is supported by the universal joint 22, even if the operation lever 20 is tilted in any direction, one or two of pistons 40 perform a stroke, and the remaining pistons 40 are in a state of being maintained at a neutral position.

When the piston 40 performs a stroke with a tilt of the operation lever 20, the spool 50 performs a stroke downward via the ring plate 60 and the output pressure adjusting spring 63, whereby the communication hole 52 of the spool 50 communicates with the pump port 35. Consequently, the oil supplied from a hydraulic pump to the pump port 35 is supplied to the supply passage 51 of the spool 50 through the communication hole 52, whereby the pilot oil pressure is output from the pilot output portion 34 of the device body 10.

Here, the stroke amount in a downward direction of the spool 50 is an amount in which the pressure of the oil supplied to the supply passage 51 and the energizing force of the output pressure adjusting spring 63 interposed between it and the ring plate 60 are balanced. Accordingly, from the pilot output portion 34 of the device body 10, it is possible to supply a pilot oil pressure having a pressure in accordance with the operation force and the operating direction of the operation lever 20.

(Processing of Operation Lever Stroke Detection System)

During these operations, electric signals are output from the magnetic field detection sensors 71 to the input signal processor 100 in accordance with a change in the direction of magnetic fields along with the stroke of the piston 40, and detection signals in accordance with the operation force and the operating direction of the operation lever 20 are output to the EPC valve 201 of the work machine through the abnormality determination device 101.

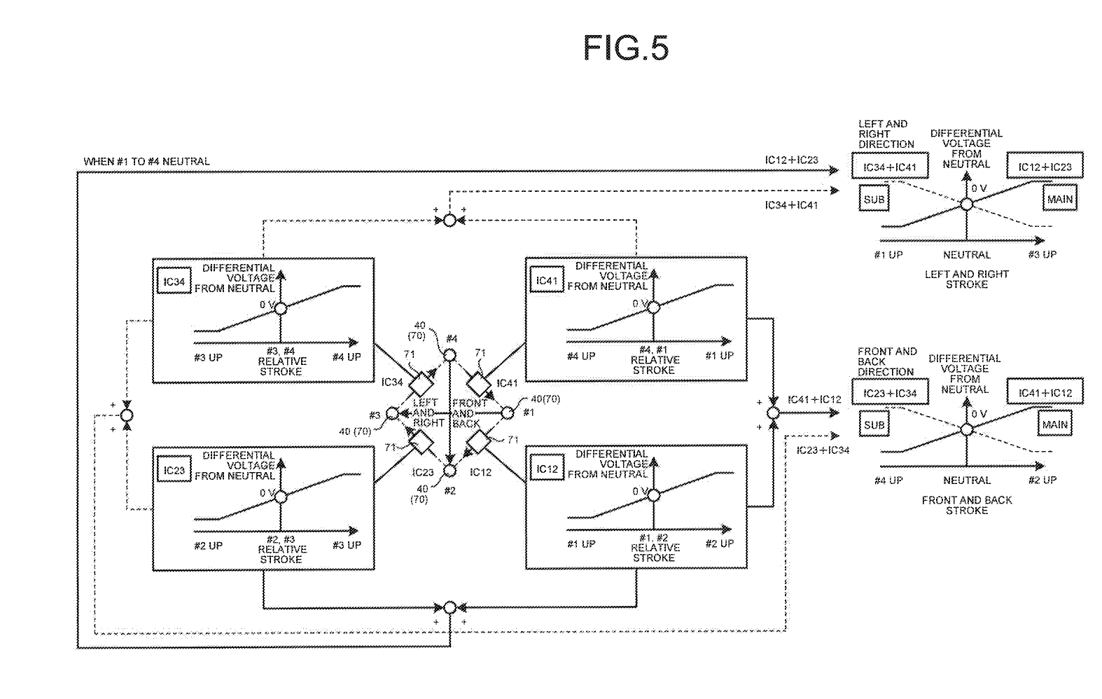

FIGS. 5 to 9 schematically illustrate contents of processing performed by the input signal processor 100 and the abnormality determination device 101. Hereinafter, processing contents of the input signal processor 100 and the abnormality determination device 101 will be described with reference to these drawings, along with detailed description of the characteristics of the operation lever stroke detection system. It should be noted that in the below description, it is assumed that the four pistons 40 are arranged at positions of three o'clock, six o'clock, nine o'clock, and twelve o'clock on a clock for convenience, and the piston 40 arranged at a three o'clock position is referred to as a #1 piston 40, the piston 40 arranged at a six o'clock position is referred to as a #2 piston 40, the piston 40 arranged at a nine o'clock position is referred to as a #3 piston 40, and the piston 40 arranged at a twelve o'clock position is referred to as a #4 piston 40.

Further, the magnetic field detection sensor 71 between the #1 piston 40 and the #2 piston 40 is referred to as an IC12 detection sensor 71, the magnetic field detection sensor 71 between the #2 piston 40 and the #3 piston 40 is referred to as an IC23 detection sensor 71, the magnetic field detection sensor 71 between the #3 piston 40 and the #4 piston 40 is referred to as an IC 34 detection sensor 71, and the magnetic field detection sensor 71 between the #4 piston 40 and the #1 piston 40 is referred to as an IC41 detection sensor 71. Further, a direction linking the #1 piston 40 and the #3 piston 40 is defined as a left and right direction, and a direction linking the #4 piston 40 and the #2 piston 40 is defined as a front and back direction.

As illustrated in FIG. 5, in a state where the operation lever 20 is arranged in an upright posture, electric signals (0 V) are output from all of the magnetic field detection sensors 71.

The input signal processor 100, to which electric signals are input, performs processing to acquire four addition results by adding electric signals of adjacent magnetic field detection sensors 71, and performs processing to give the addition results to the abnormality determination device 101. The abnormality determination device 101, to which the four addition results are given, performs processing to further add addition results at positions diagonal to each other among the four addition results and calculate the sum. If the operation lever 20 is arranged in an upright posture, as all electric signals given from the magnetic field detection sensor 71 to the input signal processor 100 are 0 V, all of the four addition results are 0 V, whereby the sum of the addition results at diagonal positions is also 0 V. Accordingly, from the vehicle body side controller C1, a signal showing a state where every piston 40 is arranged at a neutral position is output to the EPC valve 201. Consequently, an operation valve 203 is at a neutral position, for example, whereby a state where the hydraulic work machine 200 is stopped is maintained.

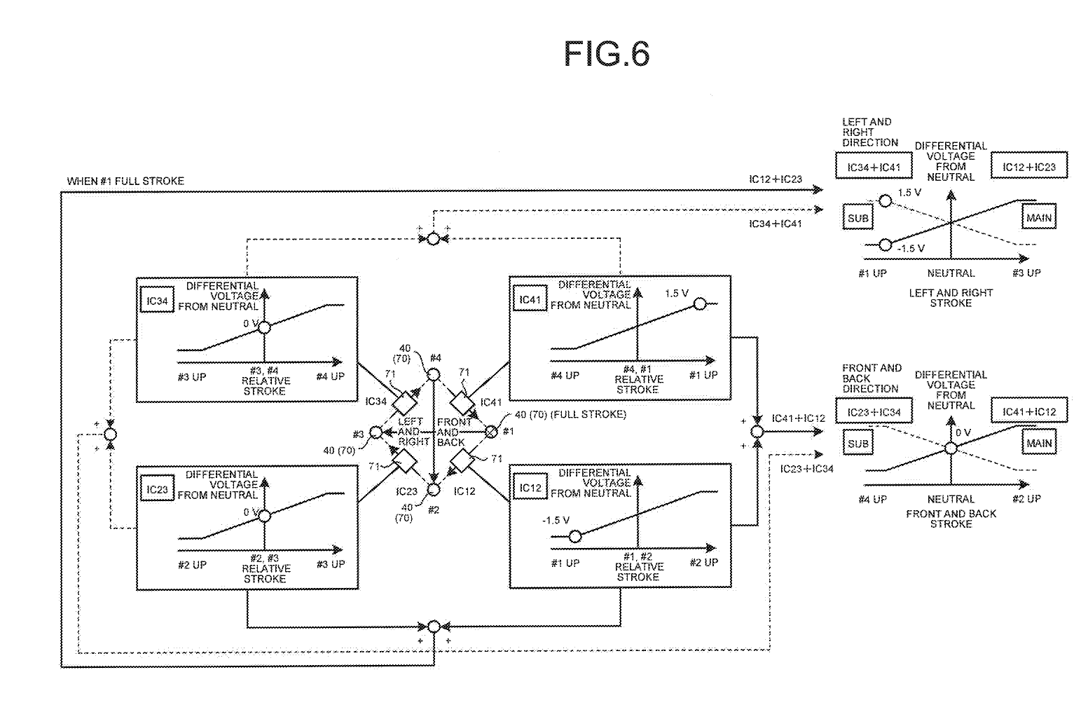

Next, as illustrated in FIG. 6, when the operation lever 20 is tilted in a direction of three o'clock and only the #1 piston 40 performs a full stroke, (−1.5 V) is output from the IC12 detection sensor 71, (0 V) is output from the IC23 detection sensor 71, (0 V) is output from the IC 34 detection sensor 71, and (1.5 V) is output from the IC41 detection sensor 71.

In the input signal processor 100 to which the electric signals are input, an addition result (−1.5 V) of the IC12 detection sensor 71 and the IC23 detection sensor 71, an addition result (0 V) of the IC23 detection sensor 71 and the IC 34 detection sensor 71, an addition result (1.5 V) of the IC 34 detection sensor 71 and the IC41 detection sensor 71, and an addition result (0 V) of the IC41 detection sensor 71 and the IC12 detection sensor 71 are calculated, respectively, and further, a sum (0 V) of the addition result (−1.5 V) of the IC12 detection sensor 71 and the IC23 detection sensor 71 and the addition result (1.5 V) of the IC 34 detection sensor 71 and the IC41 detection sensor 71, which are at diagonal positions, and also a sum (0 V) of the addition result (0 V) of the IC23 detection sensor 71 and the IC 34 detection sensor 71 and the addition result (0 V) of the IC41 detection sensor 71 and the IC12 detection sensor 71, are calculated respectively in the abnormality determination device 101. Accordingly, from the vehicle side controller C1, detection signals indicating that the addition result (0 V) of the IC41 detection sensor 71 and the TC12 detection sensor 71 is the stroke amount in a front and back direction, and the addition result (−1.5 V) of the IC12 detection sensor 71 and the IC23 detection sensor 71 is the stroke amount in a left and right direction, are output to the EPC valve 201. This means that detection signals, indicating that the #2 piston 40, the #3 piston 40, and the #4 piston 40 are arranged at neutral positions and only the #1 piston 40 performs a full stroke, are output. Consequently, the operation valve 203 is switched in accordance with the operating state of the operation lever 20, and the hydraulic work machine 200 moves to the right side, for example.

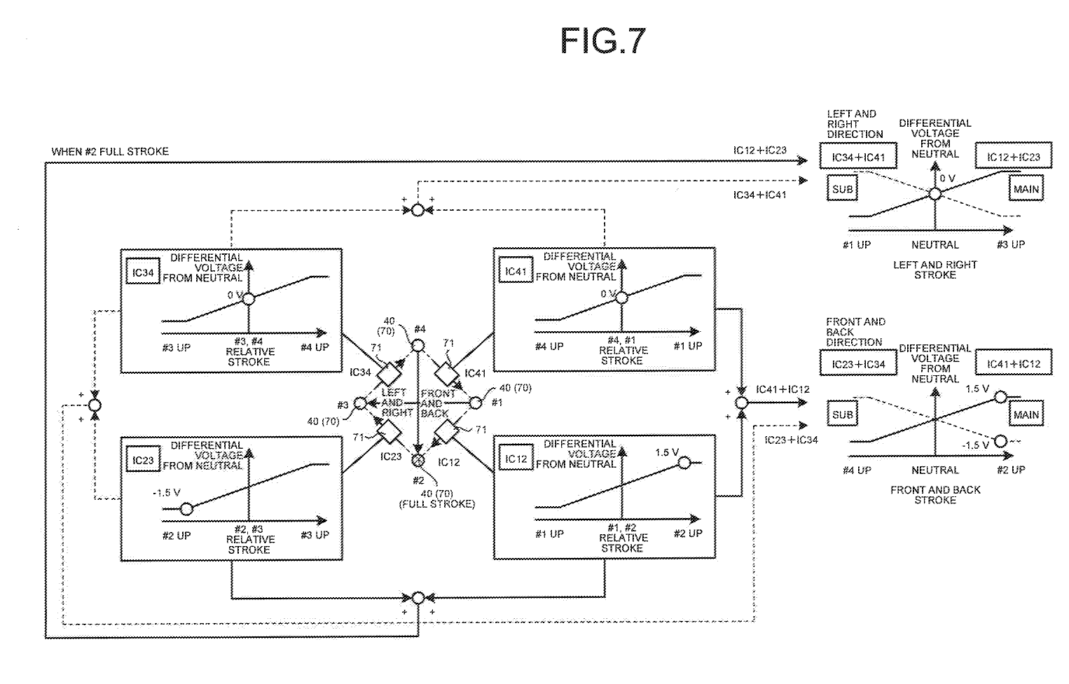

Next, when the operation lever 20 is tilted in a direction of six O'clock and only the #2 piston 40 performs a full stroke, as illustrated in FIG. 7, (1.5 V) is output from the IC12 detection sensor 71, (−1.5 V) is output from the IC23 detection sensor 71, (0 V) is output from the IC 34 detection sensor 71, and (0 V) is output from the IC41 detection sensor 71.

In the input signal processor 100 to which these electric signals are input, an addition result (0 V) of the IC12 detection sensor 71 and the IC23 detection sensor 71, an addition result (−1.5 V) of the IC23 detection sensor 71 and the IC 34 detection sensor 71, an addition result (0 V) of the IC 34 detection sensor 71 and the IC41 detection sensor 71, and an addition result (1.5 V) of the IC41 detection sensor 71 and the IC12 detection sensor 71 are calculated, respectively, and further, a sum (0 V) of the addition result (0 V) of the IC12 detection sensor 71 and the IC23 detection sensor 71 and the addition result (0 V) of the IC 34 detection sensor 71 and the IC41 detection sensor 71, which are at diagonal positions, and also a sum (0 V) of the addition result (−1.5 V) of the IC23 detection sensor 71 and the IC 34 detection sensor 71 and the addition result (1.5 V) of the IC41 detection sensor 71 and the IC12 detection sensor 71, are calculated respectively in the abnormality determination device 101. Accordingly, from the vehicle side controller C1, detection signals indicating that the addition result (1.5 V) of the IC41 detection sensor 71 and the IC12 detection sensor 71 is the stroke amount in the front and back direction, and the addition result (0 V) of the IC12 detection sensor 71 and the IC23 detection sensor 71 is the stroke amount in the left and right direction, are output to the EPC valve 201. This means that detection signals, indicating that the #1 piston 40, the #3 piston 40, and the #4 piston 40 are arranged at neutral positions and only the #2 piston 40 performs a full stroke, are output. Consequently, the operation valve 203 is switched in accordance with the operating state of the operation lever 20, and the hydraulic work machine 200 moves to a back side, for example.

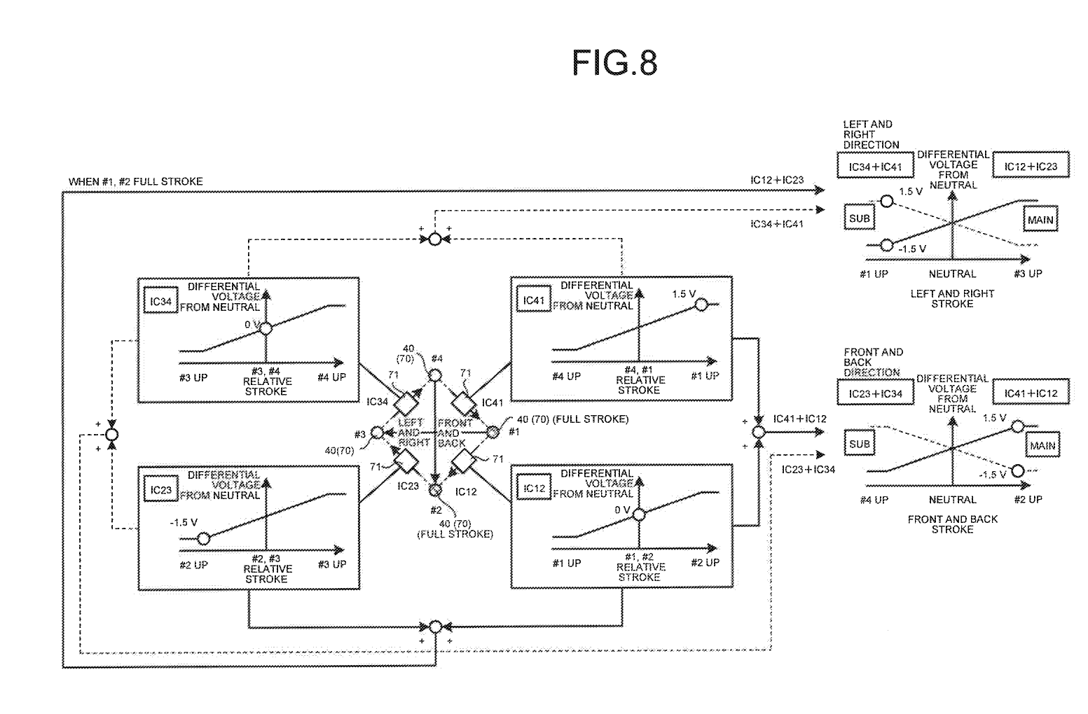

Next, when the operation lever 20 is tilted in an intermediate direction between three o'clock and six O'clock and both the #1 piston 40 and the #2 piston 40 perform a full stroke, as illustrated in FIG. 8, (0 V) is output from the IC12 detection sensor 71, (−1.5 V) is output from the IC23 detection sensor 71, (0 V) is output from the IC 34 detection sensor 71, and (1.5 V) is output from the IC41 detection sensor 71.

In the input signal processor 100 to which these electric signals are input, an addition result (−1.5 V) of the IC12 detection sensor 71 and the IC23 detection sensor 71, an addition result (−1.5 V) of the IC23 detection sensor 71 and the IC 34 detection sensor 71, an addition result (1.5 V) of the IC 34 detection sensor 71 and the IC41 detection sensor 71, and an addition result (1.5 V) of the IC41 detection sensor 71 and the IC12 detection sensor 71 are calculated, respectively, and further, a sum (0 V) of the addition result (−1.5 V) of the TC12 detection sensor 71 and the IC23 detection sensor 71 and the addition result (1.5 V) of the IC 34 detection sensor 71 and the IC41 detection sensor 71, which are at diagonal positions, and also a sum (0 V) of the addition result (−1.5 V) of the IC23 detection sensor 71 and the IC 34 detection sensor 71 and the addition result (1.5 V) of the IC41 detection sensor 71 and the IC12 detection sensor 71, are calculated respectively in the abnormality determination device 101. Accordingly, from the vehicle side controller C1, detection signals indicating that the addition result (1.5 V) of the IC41 detection sensor 71 and the IC12 detection sensor 71 is the stroke amount in the front and back direction, and the addition result (−1.5 V) of the IC12 detection sensor 71 and the IC23 detection sensor 71 is the stroke amount in the left and right direction, are output to the EPC valve 201. This means that detection signals, indicating that the #3 piston 40 and the #4 piston 40 are arranged at neutral positions and the #1 piston 40 and the #2 piston 40 perform a full stroke, are output. Consequently, the operation valve 203 is switched in accordance with the operating state of the operation lever 20, and the hydraulic work machine 200 moves to a right back side, for example.

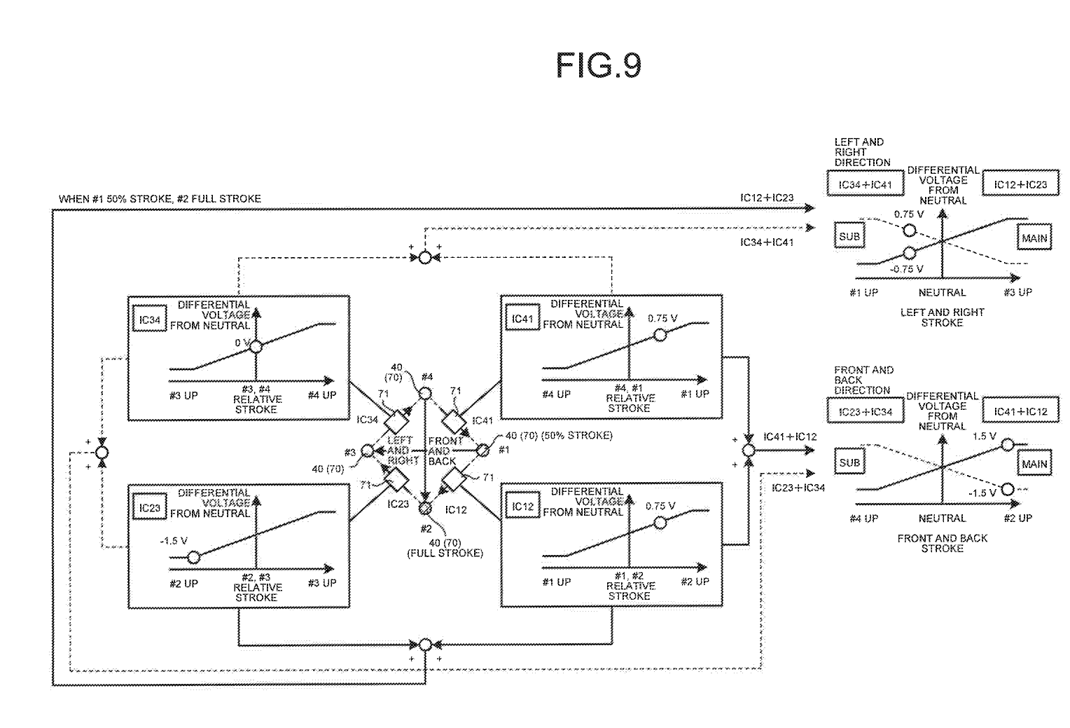

Next, when the operation lever 20 is tilted in a direction of five o'clock and the #1 piston 40 performs a 50% stroke and the #2 piston 40 performs a full stroke, as illustrated in FIG. 9, (0.75 V) is output from the IC12 detection sensor 71, (−1.5 V) is output from the IC23 detection sensor 71, (0 V) is output from the IC 34 detection sensor 71, and (0.75 V) is output from the IC41 detection sensor 71.

In the input signal processor 100 to which these electric signals are input, an addition result (−0.75 V) of the IC12 detection sensor 71 and the IC23 detection sensor 71, an addition result (−1.5 V) of the IC23 detection sensor 71 and the IC 34 detection sensor 71, an addition result (0.75 V) of the IC 34 detection sensor 71 and the IC41 detection sensor 71, and an addition result (1.5 V) of the IC41 detection sensor 71 and the IC12 detection sensor 71 are calculated, respectively, and further, a sum (0 V) of the addition result (−0.75 V) of the IC12 detection sensor 71 and the IC23 detection sensor 71 and the addition result (0.75 V) of the IC 34 detection sensor 71 and the IC41 detection sensor 71, which are at diagonal positions, and also a sum (0 V) of the addition result (−1.5 V) of the IC23 detection sensor 71 and the IC 34 detection sensor 71 and the addition result (1.5 V) of the IC41 detection sensor 71 and the IC12 detection sensor 71, are calculated respectively in the abnormality determination device 101. Accordingly, from the vehicle side controller C1, detection signals indicating that the addition result (1.5 V) of the IC41 detection sensor 71 and the IC12 detection sensor 71 is the stroke amount in the front and back direction, and the addition result (−0.75 V) of the IC12 detection sensor 71 and the IC23 detection sensor 71 is the stroke amount in the left and right direction, are output to the EPC valve 201. This means that detection signals, indicating that the #3 piston 40 and the #4 piston 40 are arranged at neutral positions and the #1 piston 40 performs a 50% stroke and the #2 piston 40 performs a full stroke, are output. Consequently, the operation valve 203 is switched in accordance with the operating state of the operation lever 20, and the hydraulic work machine 200 moves to a slightly right back side, for example.

It should be noted that in any of the above-described examples, if any of the sum of the addition result of the IC12 detection sensor 71 and the IC23 detection sensor 71 and the addition result of the IC 34 detection sensor 71 and the IC41 detection sensor 71, which are at diagonal positions, and the sum of the addition result of the IC23 detection sensor 71 and the IC 34 detection sensor 71 and the addition result of the IC41 detection sensor 71 and the IC12 detection sensor 71 is not 0 V, in the abnormality determination device 101, it is determined that an electric signal output from at least one of the four magnetic field detection sensors 71 is not proper, and that there is an abnormality. If it is determined by the abnormality determination device 101 that there is an abnormality, an error signal is generated and output to the monitor 202. Accordingly, in that case, the hydraulic work machine 200 does not operate, and an abnormality occurrence state is notified by the error signal output to the monitor 202.

As described above, according to the operation lever unit U1, as a change in relative positions of the pistons 40 is detected in accordance with the changes in the directions of the magnetic fields between the magnets 70 provided to the pistons 4, there is no need to provide the magnetic field detection sensor 71 to each of the pistons 40. As such, by providing four magnetic field detection sensors 71 with respect to four pistons 40, in addition that detection signals can be output in accordance with the stroke amounts of the pistons 40 from the neutral position, the stroke amount of each of the pistons 40 can also be detected in a duplicated manner by another magnetic field detection sensor 71. Thereby, it is possible to reduce the number of signal lines, and further, to ensure the reliability of the detection results.

(First Modification)

It should be noted that if there is no need to detect the stroke amounts of the pistons 40 in a duplicated manner, by providing the magnetic field detection sensors 71 only at three arbitrary positions between the four pistons 40, it is possible to output detection signals in accordance with the stroke amounts of the pistons 40 from a neutral position. In that case, the abnormality determination device 101 on the vehicle body side controller C1 is also unnecessary. As such, it is only necessary to output detection signals in accordance with the operating state of the operation lever 20 from the vehicle body side controller C1 to the EPC valve 201 directly.

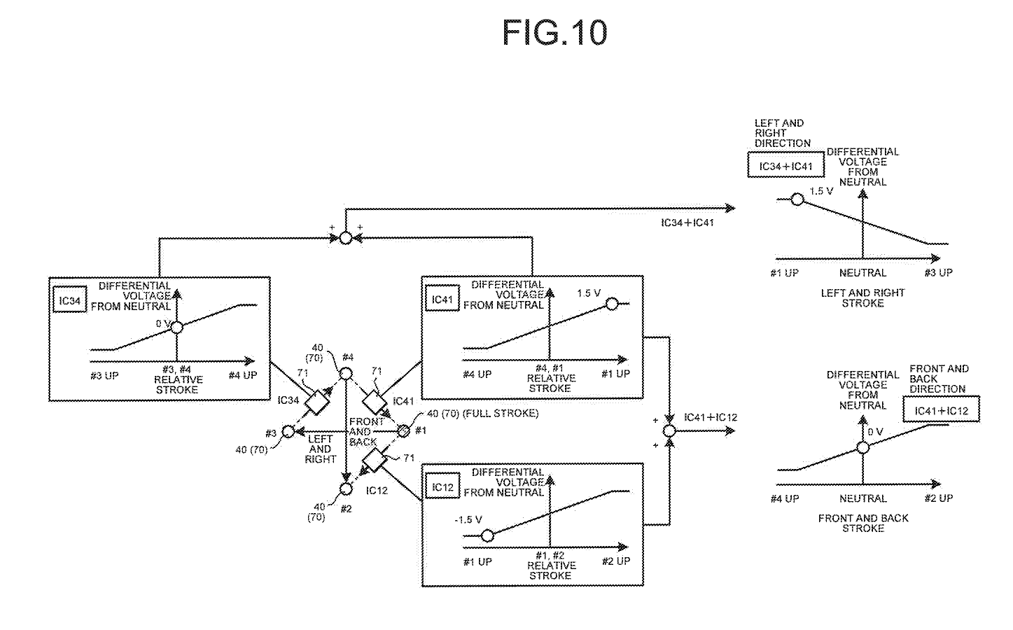

FIG. 10 illustrates a first modification of the present invention in which the magnetic field detection sensors 71 are provided at only three arbitrary positions between the four pistons 40, schematically illustrating the content of processing performed in the input signal processor 100 when the operation lever 20 is tilted in a direction of three o'clock and only the #1 piston 40 performs a full stroke. In this modification, the IC23 detection sensor 71 is omitted compared with the embodiment.

In this modification, from electric signals output from the IC 34 detection sensor 71, the IC41 detection sensor 71, and the IC12 detection sensor 71, by calculating an addition result (1.5 V) of the IC 34 detection sensor 71 and IC41 detection sensor 71 and an addition result (0 V) of the IC41 detection sensor 71 and the IC12 detection sensor 71, it is possible to output detection signals indicating that the addition result (0 V) of the IC41 detection sensor 71 and the IC12 detection sensor 71 is the stroke amount in the front and back direction, and the addition result (1.5 V) of the IC 34 detection sensor 71 and the IC41 detection sensor 71 is the stroke amount in the left and right direction. As such, detection signals indicating that the #2 piston 40, the #3 piston 40, and the #4 piston 40 are arranged at neutral positions respectively, and only the #1 piston 40 performs a full stroke.

(Second Modification)

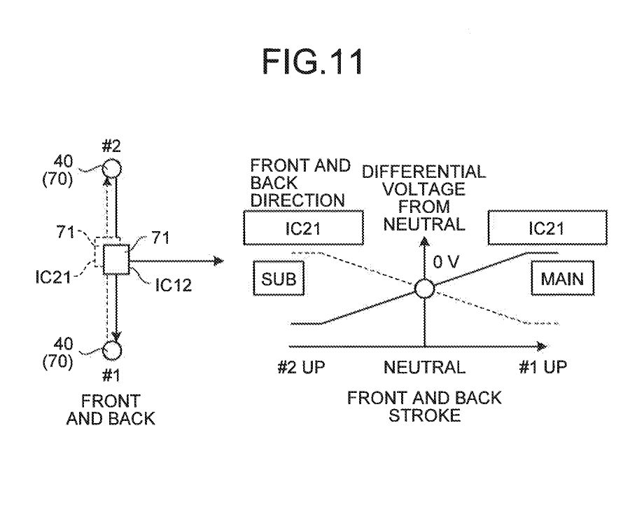

Further, while the embodiment described above exemplary shows the operation lever unit U1 including four pistons 40, as illustrated in a second modification of FIG. 11, it is possible to configure an operation lever unit including two pistons 40. In the case of an operation lever unit including two pistons 40, by providing sole magnetic field detection sensor 71 between them, it is possible to output detection signals in accordance with the stroke amounts from the neutral position of the respective pistons 40. In the case of detecting the stroke amounts of the pistons 40 in a duplicated manner, it is only necessary to dispose two magnetic field detection sensors 71 in total, one for each, on both front and rear sides of the substrate 72 such that the sum of the detection results thereof becomes a set value (0 V).

Further, while the embodiment described above exemplary shows the operation lever unit U1 which outputs a pilot oil pressure along with the detection signals, the configuration of outputting a pilot oil pressure is not necessarily required. Specifically, in the operation lever unit U1 illustrated in FIG. 1, it is not necessary to provide the lower body element 13 of the device body 10, and the sleeve portion 42 and the spool 50 of the piston 40.

### REFERENCE SIGNS LIST

10 device body
20 operation lever
40 piston
41 rod portion
70 magnet
71 magnetic field detection sensor
72 substrate
100 input signal processor
101 abnormality determination device
C1 vehicle body side controller
U1 operation lever unit

1. A stroke detection device comprising:
four rods provided, moveably along respective axial directions, side by side on a same circumference of a device body, the stroke detection device detecting a change in relative positions of the four rods at a time the rods perform a stroke with respect to the device body;
a magnet disposed to each of the rods such that a magnetic field is generated between rods adjacent to each other on the circumference and that the magnetic field varies at a time the rods adjacent to each other on the circumference perform a stroke relatively; and
magnetic field detection units disposed on at least three positions between the magnets adjacent to each other in the device body, each of the magnetic field detection unit detecting the magnetic field between the magnets and outputting an electric signal in accordance with the detected magnetic field.

2. The stroke detection device according to claim 1, wherein
the four rods are disposed at positions having equal intervals from each other on the circumference, each of the rods is arranged at a predetermined neutral position with respect to the device body at a time no operation force is applied thereto, and one or two of the rods perform a stroke from the neutral positions in accordance with magnitude of an operation force at a time the operation force is applied thereto while at least two of the rods maintain the neutral positions, and
the stroke detection device further comprises an input signal processing unit configured to generate a detection signal in accordance with a change in a position of each of the rods with respect to the device body, based the electric signal output from each of the magnetic field detection units.

3. The stroke detection device according to claim 2, wherein
the respective magnetic field detection units are configured to output electric signals having a same value for same relative positions of a rod positioned on an upstream side and a rod positioned on a downstream side which are previously set along the circumference on which the four rods are provided side by side, and
the input signal processing unit is configured to acquire two addition results by adding the electric signals output from the magnetic field detection units adjacent to each other, from among the respective electric signals provided from the three magnetic field detection units, and set the acquired two addition results as detection signals, respectively.

4. A stroke detection system comprising:
the stroke detection device according to claim 3, wherein the magnetic field detection unit is disposed at each of four positions between the magnets adjacent to each other in the device body, and the input signal processing unit is configured to acquire four addition results by adding the electric signals output from the magnetic field detection unit adjacent to each other, from among respective electric signals provided from the four magnetic field detection units, and generate the detection signals; and
an abnormality determination device configured to perform processing to further add addition results of positions diagonal to each other from among the four addition results acquired through the input signal processing unit to calculate a sum, set each of two adjacent addition results, from among the four addition results, as detection signals at a time the calculated sum is a predetermined value, and generate an error signal indicating that an abnormality occurs at a time the calculated sum is not the predetermined value.

5. A stroke detection method for detecting a change in relative positions of four rods at a time at least one or two of the four rods perform a stroke with respect to a device body, wherein the four rods are provided, moveably along respective axial directions, side by side at positions having equal intervals from each other on a same circumference of the device body, and configured such that each of the four rods is arranged at a predetermined neutral position with respect to the device body at a time no operation force is applied thereto, that one or two of the rods perform a stroke from the neutral positions in accordance with magnitude of an operation force at a time the operation force is applied thereto while at least two of the rods maintain the neutral positions, and that a direction of the magnetic field between the rods vary at a time the rods adjacent to each other perform a stroke relatively, the method comprising:
detecting magnetic fields at at least three positions between the rods adjacent to each other; and
specifying a rod which performs a stroke from the neutral position and a stroke amount of the rod based on a direction of each of the detected magnetic fields.

6. An operation lever unit comprising:
the stroke detection device according to claim 1; and
an operation lever disposed tiltably with respect to the device body, wherein
the operation lever unit is configured such that the rod performs a stroke with respect to the device body in accordance with an operating state of the operation lever at a time the operation lever is operated with respect to the device body.

7. An operation lever stroke detection system comprising:
the stroke detection device according to claim 3, wherein the magnetic field detection unit is disposed at each of four positions between the magnets adjacent to each other in the device body, and the input signal processing unit is configured to acquire four addition results by adding the electric signals output from the magnetic field detection unit adjacent to each other, from among respective electric signals provided from the four magnetic field detection units, and generate the detection signals;
an abnormality determination device configured to perform processing to further add addition results of positions diagonal to each other from among the four addition results acquired through the input signal processing unit to calculate a sum, set each of two adjacent addition results, from among the four addition results, as detection signals at a time the calculated sum is a predetermined value, and generate an error signal indicating that an abnormality occurs at a time the calculated sum is not the predetermined value; and
an operation lever disposed tiltably with respect to the device body, wherein
the operation lever unit is configured such that the rod performs a stroke with respect to the device body in accordance with an operating state of the operation lever at a time the operation lever is operated with respect to the device body.

8. A stroke detection device comprising:
two rods provided, movably along respective axial directions, to a device body side by side, the stroke detection device detecting a change in relative positions of the rods;
a magnet provided to each of the two rods such that a magnetic field is generated between the two rods and that the magnetic field varies at a time the rods perform a stroke relatively; and
a magnetic field detection unit disposed at a position between the magnets in the device body, the magnetic field detection unit detecting the magnetic field between the magnets and outputting an electric signal in accordance with the detected magnetic field.

9. A stroke detection method for detecting a change in relative positions of two rods provided, movably along the respective axial directions, to a device body side by side, the method comprising:
detecting a direction of a magnetic field between the two rods; and
detecting a change in the relative positions of the two rods based on the detected direction of the magnetic field.
